(19) United States
(12) Patent Application Publication
(10) Pub. No.: US 2015/0315387 A1
(43) Pub. Date: Nov. 5, 2015

(54) Polymer And Graphene Blended Electroactive Composite Coating Material And Method For Preparing The Same

(71) Applicant: CHUNG YUAN CHRISTIAN UNIVERSITY, Tao-Yuan (TW)

(72) Inventors: Jui-Ming Yeh, Tao-Yuan (TW); Kung-Chin Chang, Tao-Yuan (TW); Chien-Hua Hsu, Tao-Yuan (TW); Wei-Fu Ji, Tao-Yuan (TW); Hsin-I Lu, Tao-Yuan (TW); Chi-Hao Chang, Tao-Yuan (TW); Wei-Yi Li, Tao-Yuan (TW); Tsao-Li Chuang, Tao-Yuan (TW); Wei-Ren Liu, Tao-Yuan (TW); Mei-Hui Tsai, Tao-Yuan (TW)

(73) Assignee: CHUNG YUAN CHRISTIAN UNIVERSITY, Tao-Yuan (TW)

(21) Appl. No.: 14/294,517

(22) Filed: Jun. 3, 2014

(30) Foreign Application Priority Data
May 2, 2014 (TW) 103115876

(51) Int. Cl. C09D 5/08

(52) U.S. Cl. CPC C09D 5/08

(57) ABSTRACT

The present invention provides a polymer and graphene blended electroactive composite coating material and method for preparing the same. The composite coating material is a composite material formed by blending a specific polymer and graphene; where the specific polymer is formed by polymerization of (A) aniline oligomer and (B) amino reactive monomer together with (C) modified graphene and is a kind of polymer selected by the group consisting of the following: epoxy resin, polyimide, polyamide, polyurethane, polylactic acid; (C) modified graphene is uniformly dispersed in the matrix of the specific polymer but not involved in polymerization; and the composite coating material is electroactive.

### BACKGROUND OF THE INVENTION

1. Field of the Invention

The present invention is generally related to a corrosion resistant material and the method for preparing the same, and more particularly to a polymer and graphene blended electroactive composite coating material and method for preparing the same.

2. Description of the Prior Art

Corrosion may be defined by the effect of mechanical strength deterioration and content loss of a material such as metal, cement, or ceramics chemically reacting with oxygen or dissolved by alkaline or acidic gas or liquid existing in surrounding environment. Corrosion of various materials is commonly seen in daily life and causes huge economic loss, especially in steel oxidative corrosion. The loss is estimated about more than 8 billion US dollars every year in US.

The condition to cause metal corrosion is considered to be redox reaction having electron transfer occurring in the system. Thus, the reaction rate of metal corrosion may be influenced by, for example, environmental temperature, oxygen content, moisture, or concentration of electrolyte, etc. that fulfills the condition of corrosion occurrence. Particularly, metal corrosion in nature is mostly electrochemical or galvanic corrosion because metal has free electrons to build up potential difference in its structure. In general, metal in environment having moisture and air will be slowly oxidized and corroded and the corrosion rate is faster in reagents like acid, base or salts. Metal in contact with air will be oxidized and corroded as well. Most of metals are formed into various salts in nature, such as metal oxides, sulfides, carbonate salts, silicates, etc. The internal energy of metal under these chemical states is lower than that under pure metal states and thus metals are formed into stable states (free energy AG<0) naturally via chemical reaction. For example, brown ferric oxide but not metallic iron exists in nature because the internal energy of ferric oxide is lower than metallic iron. Thus, under room temperature iron has inclination to be naturally oxidized to form water containing ferric oxide due to corrosion.

Recently, polymeric material is used as corrosion resistant coating material to effectively isolate factors causing corrosion and improve physical properties of protected materials. Mechanism of corrosion resistantance is to use polymeric material as an isolation layer or passivation layer to resist corrosion caused by moisture or oxygen and the reaction between the polymeric material and the protected material is conducted to strengthen the corrosion resistant ability of the protected material so as to achieve the purpose of corrosion resistant.

Electroactive polymers are used extensively as corrosion resistant coating material because of their redox property. For example, in U.S. Pat. No. 6,150,032, electroactive polymer coatings for corrosion control are disclosed where polymeric complex having two or more than two strands containing conductive polymer and copolymer is used to reduce scratch and provide resistance to electron and ion transfer so as to achieve the effect of moisture and oxygen resistance.

However in most of electronic applications, more anti-corrosive ability of a material is required. Thus, a material having higher moisture and oxygen resistance is still needed.

### SUMMARY OF THE INVENTION

In light of the above background, in order to fulfill the requirements of the industry, the present invention provides a polymer and graphene blended electroactive composite coating material and method for preparing the same, using electroactive property and graphene characteristic to further enhance corrosive resistance ability of the composite coating material.

One object of the present invention is to provide a polymer and graphene blended electroactive composite coating material using a specific polymer comprising aniline structural units and specific moieties to not only provide resistance to electron and ion transfer but also function with graphene to further promote moisture and oxygen resistance. Moreover, since graphene has high aspect ratio (ratio of length to thickness), the permeation path of gas in the material can be prolonged to reduce the corrosion rate of metal surfaces so as to further enhance corrosive resistance ability of the material.

One object of the present invention is to provide a method for preparing a polymer and graphene blended electroactive composite coating material via three steps. Not only is the specific polymer made to have aniline structural units and specific moieties but also graphene is uniformly dispersed in the structure of the specific polymer. Thus, corrosive resistance ability of the material is further enhanced.

In order to achieve the above objects, according to one embodiment of the present invention, a polymer and graphene blended electroactive composite coating material is provided. The polymer and graphene blended electroactive composite coating material is a composite material formed by blending a specific polymer and graphene; wherein the specific polymer is formed by polymerization of (A) aniline oligomer and (B) amino reactive monomer together with (C) modified graphene and is a kind of polymer selected by the group consisting of the following: epoxy resin, polyimide, polyamide, polyurethane, polylactic acid; (C) modified graphene is uniformly dispersed in matrix of the specific polymer but not involved in polymerization; and the composite coating material is electroactive.

Furthermore, according to another embodiment of the present invention, a method for preparing a polymer and graphene blended electroactive composite coating material is provided and comprises the following steps: (1) performing pre-polymerization between (A) aniline oligomer and (B) amino reactive monomer to form a macromolecule precursor (AB); (2) adding (C) modified graphene to the macromolecule precursor (AB) and mixing until becoming uniform to obtain a mixture solution; and (3) performing polymerization of the mixture solution to form a polymer and graphene blended electroactive composite coating material.

According to the polymer and graphene blended electroactive composite coating material and method for preparing the same of the present invention, a specific polymer comprising aniline structural units and specific moieties is used to not only provide resistance to electron and ion transfer but also function with graphene to further promote moisture and oxygen resistance. Moreover, since graphene has a high aspect ratio (ratio of length to thickness), the permeation path of gas in material can be prolonged to reduce the corrosion rate of metal surfaces so as to further enhance corrosive resistance ability of the material.

### BRIEF DESCRIPTION OF THE DRAWINGS

FIG. 1 shows a schematic diagram illustrating a reaction flow chart of a method for preparing a polymer and graphene blended electroactive composite coating material according to one embodiment of the present invention;

FIG. 2 shows a schematic diagram illustrating step (1) pre-polymerization between (A) aniline oligomer and (B) amino reactive monomer according to the first embodiment of the present invention;

FIGS. 3A and 3B show schematic diagrams illustrating the working electrode and device for Tafel test; and

FIG. 4 show a schematic diagram illustrating results of Tafel tests for cold-rolled steel coated with the polymer and graphene blended electroactive composite coating material of the present invention and uncoated cold-rolled steel.

### DESCRIPTION OF THE PREFERRED EMBODIMENTS

What is probed into the invention is a polymer and graphene blended electroactive composite coating material and method for preparing the same. Detail descriptions of the steps, structures and elements will be provided in the following in order to make the invention thoroughly understood. Obviously, the application of the invention is not confined to specific details familiar to those who are skilled in the art. On the other hand, the common steps, structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, a polymer and graphene blended electroactive composite coating material is disclosed. The polymer and graphene blended electroactive composite coating material is a composite material formed by blending a specific polymer and graphene; wherein the specific polymer is formed by polymerization of (A) aniline oligomer and (B) amino reactive monomer together with (C) modified graphene and is a kind of polymer selected by the group consisting of the following: epoxy resin, polyimide, polyamide, polyurethane, polylactic acid; (C) modified graphene is uniformly dispersed in matrix of the specific polymer but not involved in polymerization; and the composite coating material is electroactive.

In one embodiment, (A) aniline oligomer has 3˜8 repeating units in a molecule.

In one embodiment, (A) aniline oligomer is amino-capped aniline trimer having a structure shown by the following equation (I):

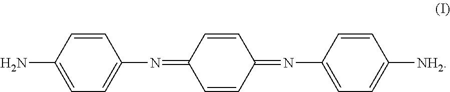 [SMILES: Nc1ccc(N=C2C=CC(=Nc3ccc(N)cc3)C=C2)cc1]

(A) aniline oligomer can be formed by the following steps: (1) dissolving phenyl-capped aniline oligomer and amino-capped aniline oligomer by a specific weight ratio in a solution (1M HCl, DMF:H₂O=5:1) and stirring rigorously under −5° C. ice bath; (2) slowly adding ammonium persulfate dissolved in 1.0N HCl (aq), continuously stirring the misture, adding distilled water to form precipitates, and filtering out the precipitates; (3) collecting solids, washing them by 1.0N HCl (aq) three times, and washing them by 1.0N NH₄OH (aq) to oxidize aniline oligomer (dark green solids turning dark blue); and (4) drying solids in a vacuum oven and using ethanol to recrystallize the dark blue product to obtain aniline oligomer. The mechanism of synthesis is shown as follows:

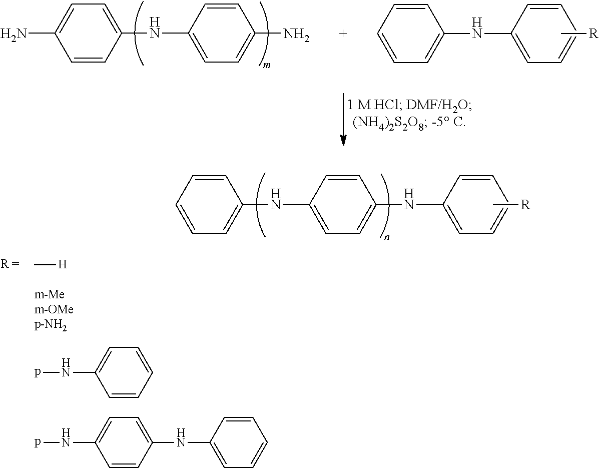

In one embodiment, (B) amino reactive monomer is selected from the group consisting of the following:

4,4′-(4,4′-isopropylidene-diphenoxy)bis(phthalic anhydride having a structure shown by (B1):

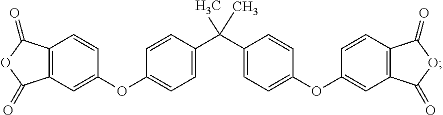 [SMILES: CC(C)(c1ccc(Oc2ccc3c(c2)C(=O)OC3=O)cc1)c1ccc(Oc2ccc3c(c2)C(=O)OC3=O)cc1]

2,2′-(((propane-2,2-diylbis(4,1-phenlene))bis(oxy)bis(methylene)) bis(oxirane) having a structure shown by (B2):

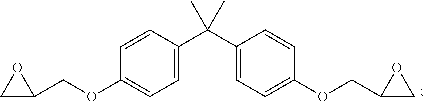 [SMILES: CC(C)(c1ccc(OCC2CO2)cc1)c1ccc(OCC2CO2)cc1]

dicarboxylic acid having a structure shown by (B3):

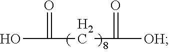

and

hexamethylene diisocyanate having a structure shown by (B4):

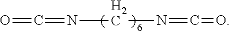

In one embodiment, (C) modified graphene comprises carboxyl, hydroxyl or amino moieties. (C) modified graphene can be made by Hummer's method or surface modification method. Specifically, for example, 8 g of graphite and 4 g of NaNO₃ are placed in 56 ml of H₂SO₄ and added with 24 g of KMnO₄. The mixture is stirred in ice bath for 2 hrs at the time graphite turns yellow brownish. 800 ml of deionized water, 5% H₂O₂ and 0.1M HCl are used to wash and the solution is diluted to have pH=5 and placed in a 50° C. vacuum oven to obtain graphene oxide. Graphene oxide can be reduced at high temperature to generate reduced graphene oxide, (C) modified graphene having carboxyl and hydroxyl moieties.

In one embodiment, the specific polymer and (C) modified graphene is bonded through linkage between oxygen moieties of the specific polymer and carboxyl, hydroxyl or amino moieties of (C) modified graphene.

In one embodiment, the polymer and graphene blended electroactive composite coating material (being 100 wt %) contains 0.1˜1.0 wt % of (C) modified graphene.

In a second embodiment of the present invention, a method for preparing a polymer and graphene blended electroactive composite coating material is disclosed. The method comprises the following steps: (1) performing pre-polymerization between (A) aniline oligomer and (B) amino reactive monomer to form a macromolecule precursor (AB); (2) adding (C) modified graphene to the macromolecule precursor (AB) and mixing until becoming uniform to obtain a mixture solution; and (3) performing polymerization of the mixture solution to form a polymer and graphene blended electroactive composite coating material.

In one embodiment, the polymer and graphene blended electroactive composite coating material (being 100 wt %) contains 0.1˜1.0 wt % of (C) modified graphene.

In one embodiment, (B) amino reactive monomer is selected from the group consisting of the following:

4,4′-(4,4′-isopropylidene-diphenoxy)bis(phthalic anhydride having a structure shown by (B1):

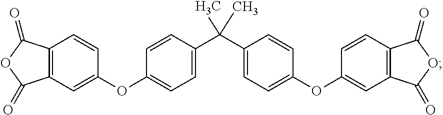 [SMILES: CC(C)(c1ccc(Oc2ccc3c(c2)C(=O)OC3=O)cc1)c1ccc(Oc2ccc3c(c2)C(=O)OC3=O)cc1]

2,2′-(((propane-2,2-diylbis(4,1-phenlene))bis(oxy)bis(methylene)) bis(oxirane) having a structure shown by (B2):

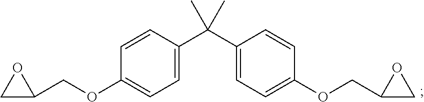 [SMILES: CC(C)(c1ccc(OCC2CO2)cc1)c1ccc(OCC2CO2)cc1]

dicarboxylic acid having a structure shown by (B3):

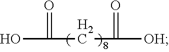

and

hexamethylene diisocyanate having a structure shown by (B4):

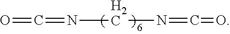

In one embodiment, (A) aniline oligomer is amino-capped aniline trimer having a structure shown by the following equation (I):

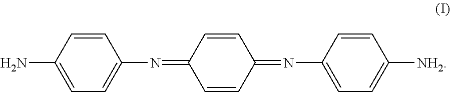 [SMILES: Nc1ccc(N=C2C=CC(=Nc3ccc(N)cc3)C=C2)cc1]

In one embodiment, (A) aniline oligomer is amino-capped aniline trimer; (B) amino reactive monomer is 4,4′-(4,4′-isopropylidene-diphenoxy)bis(phthalic anhydride having a structure shown by (B1):

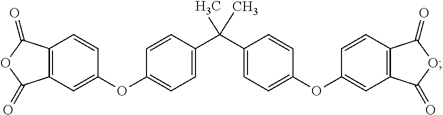 [SMILES: CC(C)(c1ccc(Oc2ccc3c(c2)C(=O)OC3=O)cc1)c1ccc(Oc2ccc3c(c2)C(=O)OC3=O)cc1]

step (3) polymerization is condensation polymerization reaction; and the specific polymer is of polyimide.

In one embodiment, (A) aniline oligomer is amino-capped aniline trimer; (B) amino reactive monomer is 2,2′-(((propane-2,2-diylbis(4,1-phenlene))bis(oxy)bis(methylene))bis(oxi rane) having a structure shown by (B2):

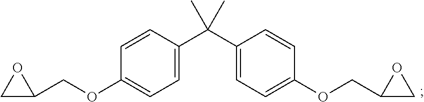 [SMILES: CC(C)(c1ccc(OCC2CO2)cc1)c1ccc(OCC2CO2)cc1]

step (3) polymerization is ring-opening polymerization reaction; and the specific polymer is of epoxy resin.

In one embodiment, (A) aniline oligomer is amino-capped aniline trimer; (B) amino reactive monomer is dicarboxylic acid having a structure shown by (B3):

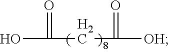

step (3) polymerization is dehydration condensation polymerization reaction; and the specific polymer is of polyamide.

In one embodiment, (A) aniline oligomer is amino-capped aniline trimer; (B) amino reactive monomer is hexamethylene diisocyanate having a structure shown by (B4):

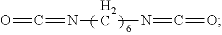

step (3) polymerization is addition polymerization reaction; and the specific polymer is of polyurethane.

In one embodiment, (C) modified graphene comprises carboxyl, hydroxyl or amino moieties.

In one embodiment, in step (1) pre-polymerization between (A) aniline oligomer and (B) amino reactive monomer a molar ratio of (A) to (B) is 1:1.

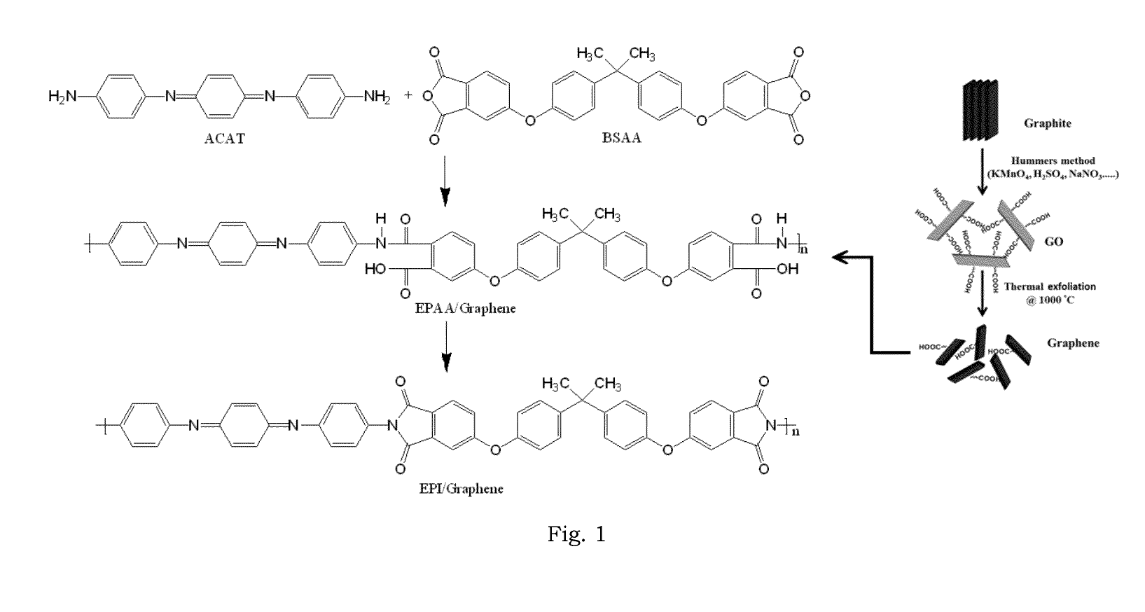

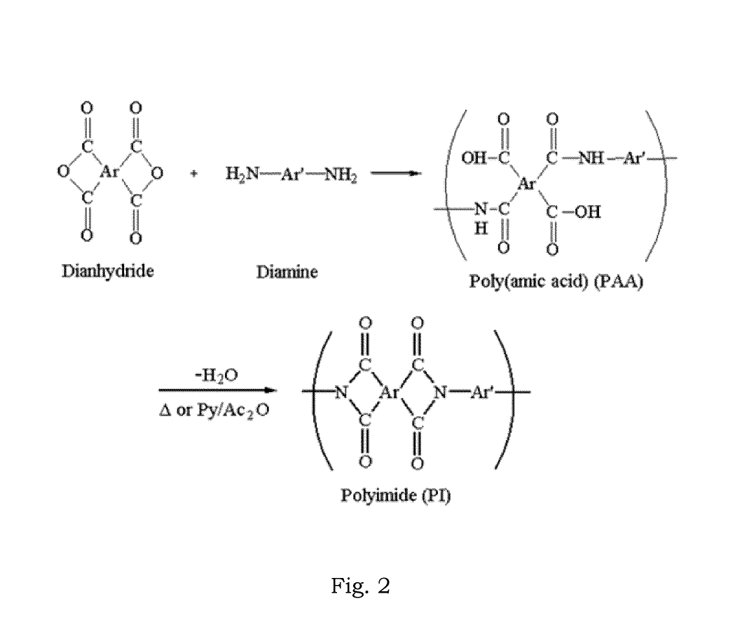

Specifically, FIG. 1 shows a schematic diagram illustrating a reaction flow chart of a method for preparing a polymer and graphene blended electroactive composite coating material according to one embodiment of the present invention. FIG. 2 shows a schematic diagram illustrating step (1) pre-polymerization between (A) aniline oligomer and (B) amino reactive monomer to form a macromolecule precursor (AB) according to the first embodiment of the present invention. In FIG. 2, in the structure of dicarboxylic anhydride, “Ar” represents a aromatic moiety such as phenyl or substituted phenyl. The substituted moiety can be for example —F, —CH₃, —CF₃ or —OH, and so forth. (B) amino reactive monomer is, for example, dicarboxylic anhydride having any structure selected from equations (B5)˜(B12):

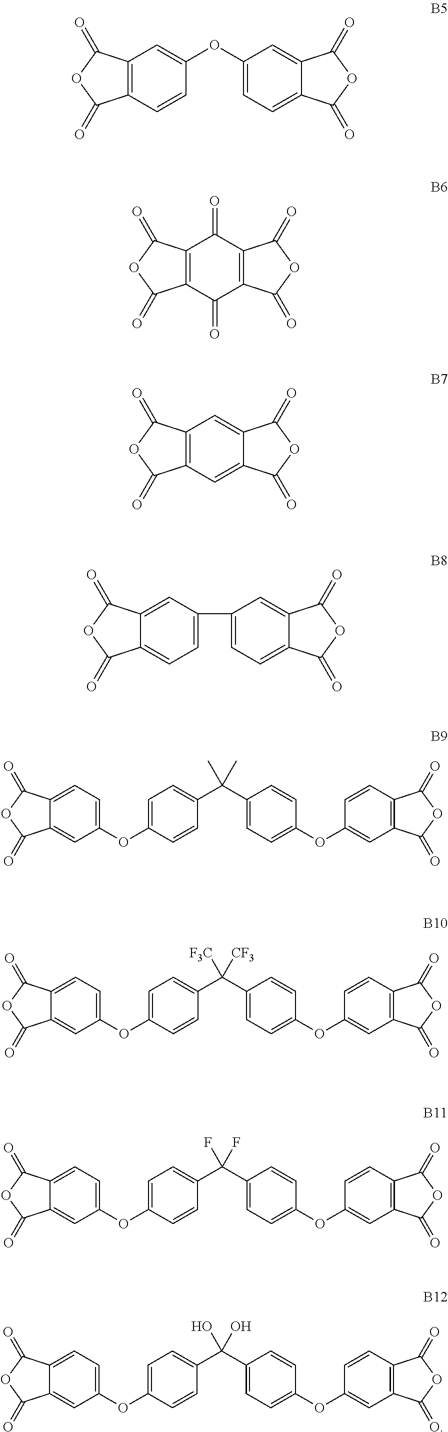

The method and conditions for preparing the polymer and graphene blended electroactive composite coating material of the present invention are shown in example 1.

### Example 1

### ACAT+BSAA

0.288 g (1 mmol) of aniline trimer (amino-capped aniline trimer; ACAT) and 0.520 g (1 mmol) of 4′-(4,4′-Isopropylidene-diphenoxy) bis(phthalic anhydride) (BSAA) are dissolved in 4 g DMAc and the mixture is stirred for 20 min under room temperature to obtain electroactive polyamic acid solution. Then, 0.5 wt % or 0.1 wt % graphene is added in the electroactive polyamic acid solution and is stirred for 30 min under room temperature to obtain electroactive polyamic acid/graphene solution (EPAA/Graphene). The EPAA/Graphene solution is coated on cold-rolled steel (1 cm×1 cm) and heated by a gradient temperature elevation method, room temperature to 80° C. in 30 min, 80° C. to 100° C. in 6 hrs, 100° C. to 150° C. in 2 hrs, 150° C. to 170° C. in 2 hrs, and back to room temperature. The EPAA/Graphene coating layer is thus formed and then heated to 250° C. to remove residual solvent and to imidize to form an electroative polyimide/graphene coating layer (EPI/graphene).

Characteristic tests of the polymer and graphene blended electroactive composite coating material:

The EPI/graphene from example 1 is used to perform the following tests, electrochemical anti-corrosive test, electroactive test, identification of passive oxide layer, and oxygen permeation analysis, to assure that the electroactive composite coating material forms a passive oxide layer on metal surface, is electroactive and has oxygen isolation effect and anti-corrosion effect.

Anti-Corrosion Tafel Tests:

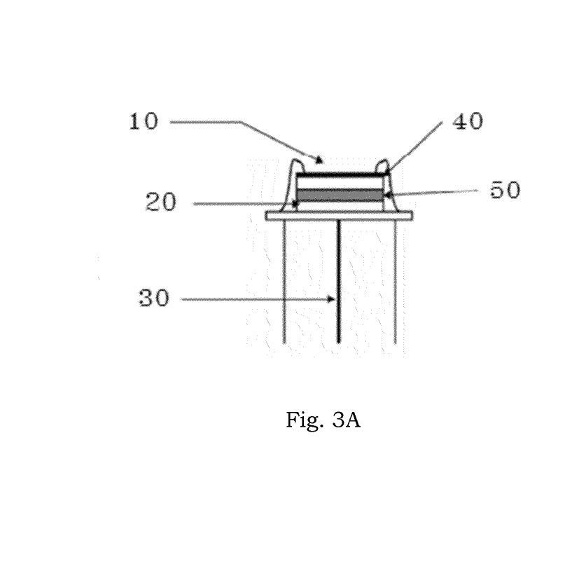

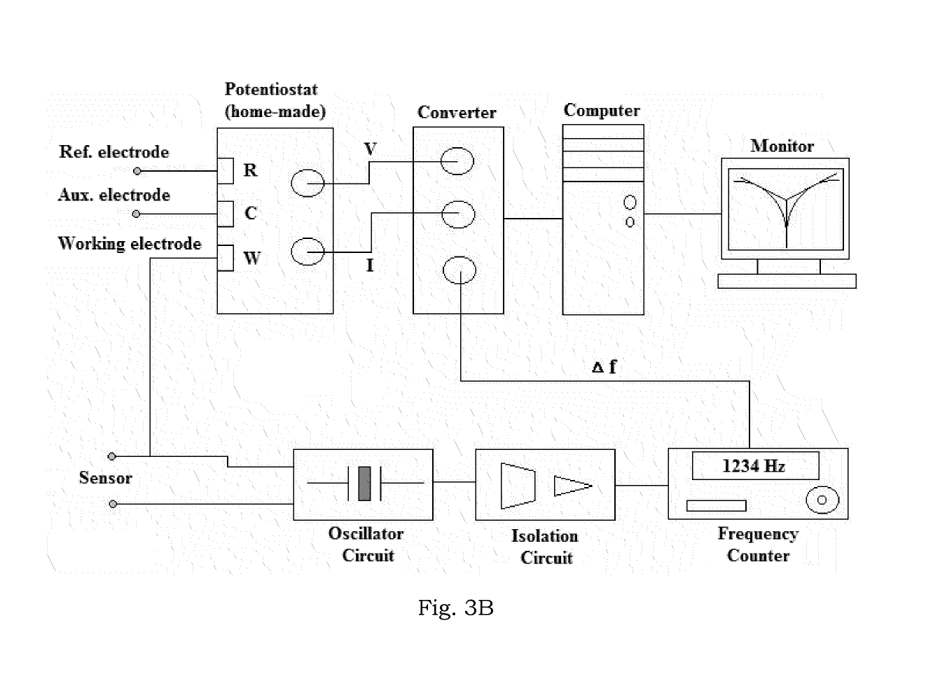

The anti-corrosion test samples are prepared as follows. Cold-rolled steel (CRS) is sand blasted to remove iron rust on surfaces and cut into a 1×1 cm² square plate. The EPI/graphene from example 1 is coated on CRS to have the coating layer with a thickness of 30±2 μm. As shown in FIG. 3A, 10 shows the test sample, 20 shows conductive silver glue, 30 shows a conducting wire, 40 shows a working iron plate, and 50 shows a mounting iron plate. The processed test plate is mounted on the working electrode and sealed with hot-melt epoxy resin. The device shown in FIG. 3B setup with all instruments and electrodes is used and connected to a cyclic voltammetry for anti-corrosion Tafel tests.

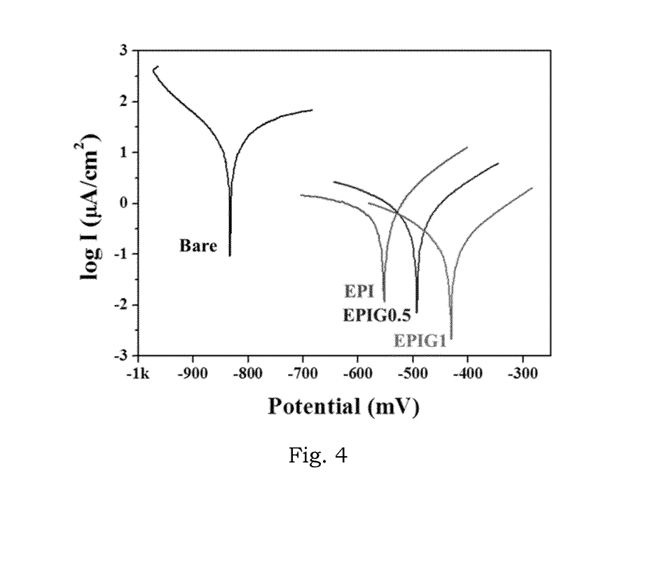

The higher the corrosion potential, the higher the polarized resistance, the lower the corrosion current, the material shows more anti-corrosive property. From the results shown in Table 1, the cold-rolled steel coated with the electroactive composite coating material has the higher corrosion potential than uncoated cold-rolled steel. The anti-corrosion effect of the composite coating material is increased with the increased adding amount of graphene. From Tafel plots shown in FIG. 4, the anodic curve and the cathodic curve form double curves and have a trend to move bottom right with the increased adding amount of graphene, meaning that the corrosion potential increases and corrosion current decreases. Therefore, the trend of Tafel plot can be used to determine the anti-corrosive ability. In Tafel plots, (a) represents cold-rolled steel (CRS); (b) represents EPI; (c) represents EPI/0.5 wt % Graphene (EPGN0.5) and (d) represents EPI/1 wt % Graphene (EPGN1).

TABLE 1

| | Electrochemical Anti-Corrosion Test | | |
|---|---|---|---|
| | E_{corr} (mV) | Rₚ (kΩ · cm²) | I_{corr} (μ/cm²) |
| Bare | −832 | 2.00 | 14.50 |
| EPI | −552 | 53.8 | 1.20 |
| EPGN0.5 | −493 | 52.2 | 0.55 |
| EPGN1 | −431 | 165.3 | 0.15 |

Electroactive Test

The above materials (b), (c) and (d) are tested by using cyclic voltammetry. It is found that the materials (b), (c) and (d) all have oxidation characteristic peaks, especially for (c) and (d). It shows that the composite coating material of the present invention is electroactive and has higher electroactive property with the increase amount of graphene.

Identification of Passive Oxide Layer:

The cross sections of CRS surface coated with the above materials (c) and (d) are observed by SEM (scanning electron microscope). It is found that a very thin passive metal oxide layer exists on the surface of CRS.

Oxygen Permeation Analysis:

The above materials (b), (c) and (d) are tested by oxygen permeation. It is found that the oxygen permeation rate is decreased with the increase of the concentration of graphene in the composite coating material, meaning that oxygen isolation increases with the increase of the concentration of graphene. Therefore, the anti-corrosive ability is increased with the increase of oxygen isolation.

To sum up, according to the polymer and graphene blended electroactive composite coating material and method for preparing the same of the present invention, a specific polymer comprising aniline structural units and specific moieties is used to not only provide resistance to electron and ion transfer but also function with graphene to further promote moisture and oxygen resistance. Moreover, since graphene has a high aspect ratio (ratio of length to thickness), the permeation path of gas in the material can be prolonged to reduce the corrosion rate of metal surfaces so as to further enhance corrosive resistance ability of the material.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A polymer and graphene blended electroactive composite coating material, being a composite material formed by blending a specific polymer and graphene; wherein the specific polymer is formed by polymerization of (A) aniline oligomer and (B) amino reactive monomer together with (C) modified graphene and is a kind of polymer selected by the group consisting of the following: epoxy resin, polyimide, polyamide, polyurethane, polylactic acid; (C) modified graphene is uniformly dispersed in matrix of the specific polymer but not involved in polymerization; and the composite coating material is electroactive.

2. The material according to claim 1, wherein (A) aniline oligomer has 3˜8 repeating units in a molecule.

3. The material according to claim 1, wherein (A) aniline oligomer is amino-capped aniline trimer having a structure shown by the following equation (I):

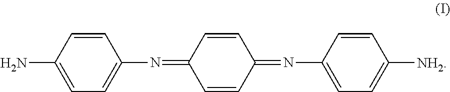 [SMILES: Nc1ccc(N=C2C=CC(=Nc3ccc(N)cc3)C=C2)cc1]

4. The material according to claim 1, wherein (B) amino reactive monomer is selected from the group consisting of the following:
4,4′-(4,4′-isopropylidene-diphenoxy)bis(phthalic anhydride having a structure shown by (B1): 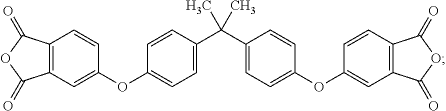 [SMILES: CC(C)(c1ccc(Oc2ccc3c(c2)C(=O)OC3=O)cc1)c1ccc(Oc2ccc3c(c2)C(=O)OC3=O)cc1]
2,2′-(((propane-2,2-diylbis(4,1-phenlene))bis(oxy)bis(methylene)) bis(oxirane) having a structure shown by (B2): 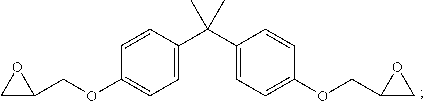 [SMILES: CC(C)(c1ccc(OCC2CO2)cc1)c1ccc(OCC2CO2)cc1]
dicarboxylic acid having a structure shown by (B3): 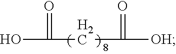
and
hexamethylene diisocyanate having a structure shown by (B4):

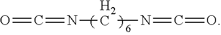

5. The material according to claim 1, wherein (C) modified graphene comprises carboxyl, hydroxyl or amino moieties.

6. The material according to claim 1, wherein the specific polymer and (C) modified graphene is bonded through linkage between oxygen moieties of the specific polymer and carboxyl, hydroxyl or amino moieties of (C) modified graphene.

7. The material according to claim 1, wherein the polymer and graphene blended electroactive composite coating material (being 100 wt %) contains 0.1˜1.0 wt % of (C) modified graphene.

8. A method for preparing a polymer and graphene blended electroactive composite coating material, comprising:
(1) performing pre-polymerization between (A) aniline oligomer and (B) amino reactive monomer to form a macromolecule precursor (AB);
(2) adding (C) modified graphene to the macromolecule precursor (AB) and mixing until becoming uniform to obtain a mixture solution; and
(3) performing polymerization of the mixture solution to form a polymer and graphene blended electroactive composite coating material.

9. The method according to claim 8, wherein the polymer and graphene blended electroactive composite coating material (being 100 wt %) contains 0.1˜1.0 wt % of (C) modified graphene.

10. The method according to claim 8, wherein (B) amino reactive monomer is selected from the group consisting of the following:
4,4′-(4,4′-isopropylidene-diphenoxy)bis(phthalic anhydride having a structure shown by (B1): 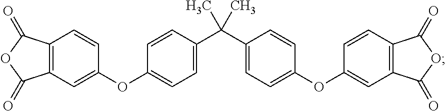 [SMILES: CC(C)(c1ccc(Oc2ccc3c(c2)C(=O)OC3=O)cc1)c1ccc(Oc2ccc3c(c2)C(=O)OC3=O)cc1]
2,2′-(((propane-2,2-diylbis(4,1-phenlene))bis(oxy)bis(methylene)) bis(oxirane) having a structure shown by (B2): 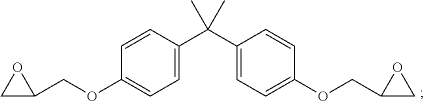 [SMILES: CC(C)(c1ccc(OCC2CO2)cc1)c1ccc(OCC2CO2)cc1]
dicarboxylic acid having a structure shown by (B3): 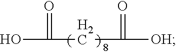
and
hexamethylene diisocyanate having a structure shown by (B4):

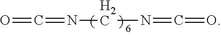

11. The method according to claim 8, wherein (A) aniline oligomer is amino-capped aniline trimer having a structure shown by the following equation (I):

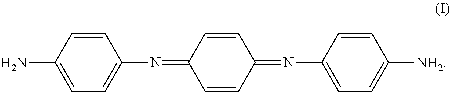 [SMILES: Nc1ccc(N=C2C=CC(=Nc3ccc(N)cc3)C=C2)cc1]

12. The method according to claim 8, wherein (A) aniline oligomer is amino-capped aniline trimer; (B) amino reactive monomer is 4,4′-(4,4′-isopropylidene-diphenoxy)bis(phthalic anhydride having a structure shown by (B1): 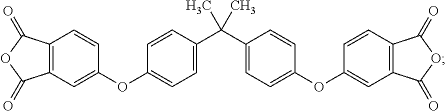 [SMILES: CC(C)(c1ccc(Oc2ccc3c(c2)C(=O)OC3=O)cc1)c1ccc(Oc2ccc3c(c2)C(=O)OC3=O)cc1]
step (3) polymerization is condensation polymerization reaction; and the specific polymer is of polyimide.

13. The method according to claim 8, wherein (A) aniline oligomer is amino-capped aniline trimer; (B) amino reactive monomer is 2,2′-(((propane-2,2-diylbis(4,1-phenlene))bis(oxy)bis(methylene))bis(oxirane) having a structure shown by (B2): 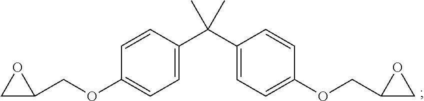 [SMILES: CC(C)(c1ccc(OCC2CO2)cc1)c1ccc(OCC2CO2)cc1]
step (3) polymerization is ring-opening polymerization reaction; and the specific polymer is of epoxy resin.

14. The method according to claim 8, wherein (A) aniline oligomer is amino-capped aniline trimer; (B) amino reactive monomer is dicarboxylic acid having a structure shown by (B3): 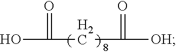
step (3) polymerization is dehydration condensation polymerization reaction; and the specific polymer is of polyamide.

15. The method according to claim 8, wherein (A) aniline oligomer is amino-capped aniline trimer; (B) amino reactive monomer is hexamethylene diisocyanate having a structure shown by (B4): 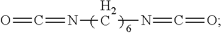
step (3) polymerization is addition polymerization reaction; and the specific polymer is of polyurethane.

16. The method according to claim 8, wherein (C) modified graphene comprises carboxyl, hydroxyl or amino moieties.

17. The method according to claim 8, wherein in step (1) pre-polymerization between (A) aniline oligomer and (B) amino reactive monomer a molar ratio of (A) to (B) is 1:1.

18. The method according to claim 8, wherein (B) amino reactive monomer is dicarboxylic anhydride having any structure selected from equations (B5)˜(B12):

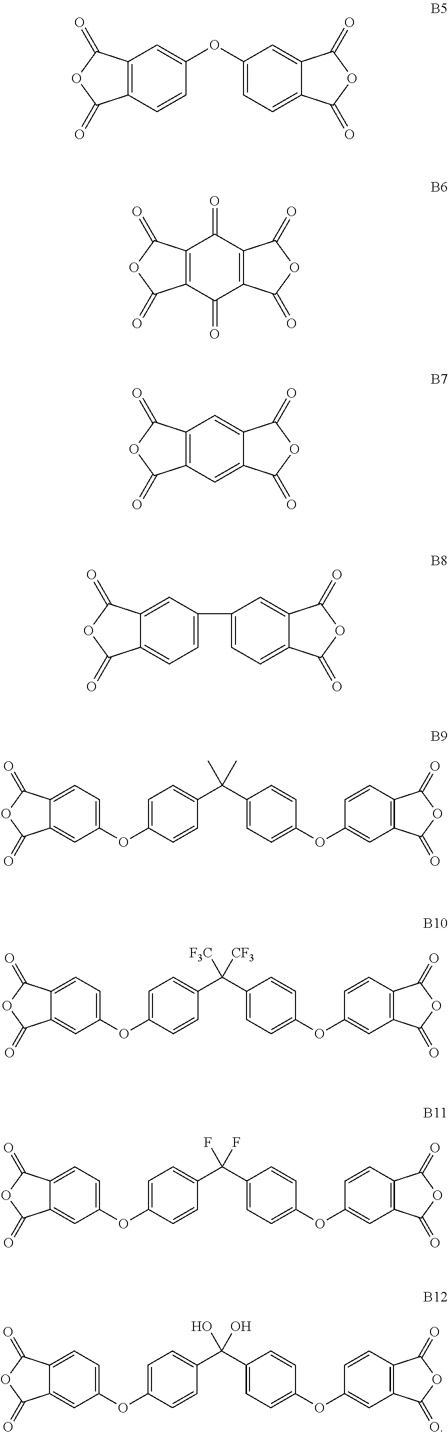

19. The material according to claim 1, wherein (B) amino reactive monomer is dicarboxylic anhydride having any structure selected from equations (B5)˜(B12): [chemical structure]
